(19) United States
(12) Patent Application Publication
(10) Pub. No.: US 2005/0211526 A1
(43) Pub. Date: Sep. 29, 2005

(54) Vehicle powertrain with bi-directional overrunning clutch

(76) Inventors: Bryan M. Averill, Portland, OR (US); Mark J. Fogelberg, Milwaukie, OR (US); Fred L. Ewer, Clackamas, OR (US)

Correspondence Address: HARNESS, DICKEY & PIERCE, P.L.C., P.O. BOX 828, BLOOMFIELD HILLS, MI, 48303, US

(21) Appl. No.: 11/085,006

(22) Filed: Mar. 18, 2005

Related U.S. Application Data
(60) Provisional application No. 60/556,100, filed on Mar. 25, 2004.
(60) Provisional application No. 60/556,126, filed on Mar. 25, 2004.

(51) Int. Cl. F16D 47/06

(52) U.S. Cl. 192/48.3; 192/36; 192/57; 192/58.41

(57) ABSTRACT

A bi-directional overrunning clutch and viscous transmission unit are combined in order to provide an on-demand four wheel drive system with having an improved construction.

### CROSS-REFERENCE TO RELATED APPLICATIONS

This application claims the benefit of U.S. Provisional Application No. 60/556,100, filed on Mar. 25, 2004 and U.S. Provisional Application No. 60/556,126, filed Mar. 25, 2004. The disclosures of the above applications are incorporated herein by reference.

### FIELD OF THE INVENTION

The present invention relates to bi-directional overrunning clutches utilized in various configurations and mating arrangements within a vehicle powertrain system.

### BACKGROUND AND SUMMARY OF THE INVENTION

Four-wheel drive vehicles generally incorporate different types of systems by which torque from a single output shaft from a power source is transferred to two output shafts for driving separate axles of a vehicle. In standard configurations of four-wheel drive vehicles, either the front or rear primary drive wheels constantly receive torque from the power source and the other set of wheels receive torque selectively. For example, for “on demand” systems, torque is selectively delivered to the other set of wheels when the primary drive wheels slip, or “part-time,” when an operator shifts to a four-wheel drive mode. Various powertrain configurations are provided for different vehicle operating conditions and requirements. One style of four-wheel drive vehicle powertrain utilizes a transfer case having an input shaft drivingly engaged with a sun gear that cooperates with a planetary gear assembly. A shifting mechanism couples one output shaft to the planetary gear assembly or directly to the input shaft to provide different ranges of operation (e.g., low range, high range). That output shaft can then be selectively coupled to a second output shaft to transfer torque thereto. Other styles of four-wheel drive powertrain systems utilize a power take-off unit for use with a front-wheel drive transaxle to provide driving torque to a rear drive axle.

One method of transferring torque between output shafts uses an overrunning roller clutch. Such a transfer case is shown in commonly assigned U.S. Pat. No. 4,124,085. U.S. Pat. No. 5,782,328, also commonly assigned, discloses an overrunning clutch utilizing a transfer case for selectively distributing torque to the secondary output shaft of the transfer case unit. In an overrunning clutch, the rollers are biased into a retired position that is biased opposite the direction of rotation by a drag member. This allows the driven member to overrun the driving member without engaging the roller bearings on the cams. However, when the driving member begins to overrun the driven member, the rollers quickly engage and torque from the driving member is transferred to the driven member. Because of the rapid engagement of the bi-directional overrunning clutch during a wheel slip, there can be felt a sudden torque that is undesirable. Accordingly, these bi-directional overrunning clutches have recently been mated with a friction clutch or viscous transmission unit which provides a limited slip during engagement of the bi-directionally overrunning clutch to provide a vehicle with an acceptable power transmission.

The present invention provides various mating arrangements and improved constructions for a bi-directional overrunning clutch and viscous transmission unit for implementation into various vehicle powertrain systems.

According to one aspect of the present invention, the clutch device includes an improved construction including an input shaft extending into a clutch housing and including a flange integrally formed on the input shaft and being disposed outside of the housing.

According to another aspect of the present invention, the overrunning clutch is provided with an inner race member that is splined to the input shaft.

According to another aspect of the present invention, the bi-directional overrunning clutch includes a brake shoe mechanism that engages a friction surface disposed directly on the housing.

According to still another aspect of the present invention, the bi-directional overrunning clutch is disposed radially within the viscous transmission unit.

According to yet another aspect of the present invention, a vehicle powertrain is provided including a multi-speed transaxle transmission with a power take-off unit having a combined bi-directional overrunning clutch and viscous transmission unit.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic diagram of a vehicle powertrain including a transaxle drivetrain having a power take-off unit for providing power to the rear wheels with a combined bi-directional overrunning clutch and viscous clutch unit for providing driving torque on demand to the rear wheels;

FIG. 2 is a cross-sectional view of the co-axial bi-directional overrunning clutch and viscous transmission unit according to the principles of the present invention;

FIG. 3 is a cross-sectional view of an alternative configuration of the bi-directional overrunning clutch and viscous transmission unit according to the principles of the present invention;

FIG. 4 is yet another embodiment of a bi-directional overrunning clutch co-axially aligned with a viscous transmission unit according to the principles of the present invention;

FIG. 5 is a cross-sectional view of still another embodiment of the co-axial bi-directional overrunning clutch and viscous transmission unit according to the principles of the present invention;

FIG. 6 is a cross-sectional view of a fifth embodiment of the bi-directional overrunning clutch and viscous transmission unit according to the principles of the present invention;

FIG. 7 is a schematic diagram of a vehicle powertrain including a transaxle drivetrain having a power take-off unit for providing power to the rear wheels with a mid-mounted bi-directional overrunning clutch and viscous transmission unit according to the principles of the present invention;

FIG. 8 is a cross-sectional view of a mid-mounted bi-directional overrunning clutch with a co-axial viscous transmission unit according to the principles of the present invention;

FIG. 9 is a cross-sectional view of a second embodiment of a mid-mounted bi-directional overrunning clutch and viscous transmission unit according to the principles of the present invention;

FIG. 10 is a schematic diagram of a vehicle powertrain including a transaxle drivetrain having a power take-off unit with a clutch built into the power take-off unit for providing driving torque on demand to the rear wheels; and

FIG. 11 is a cross-sectional view of a power take-off unit with a bi-directional overrunning clutch and viscous transmission unit according to the principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

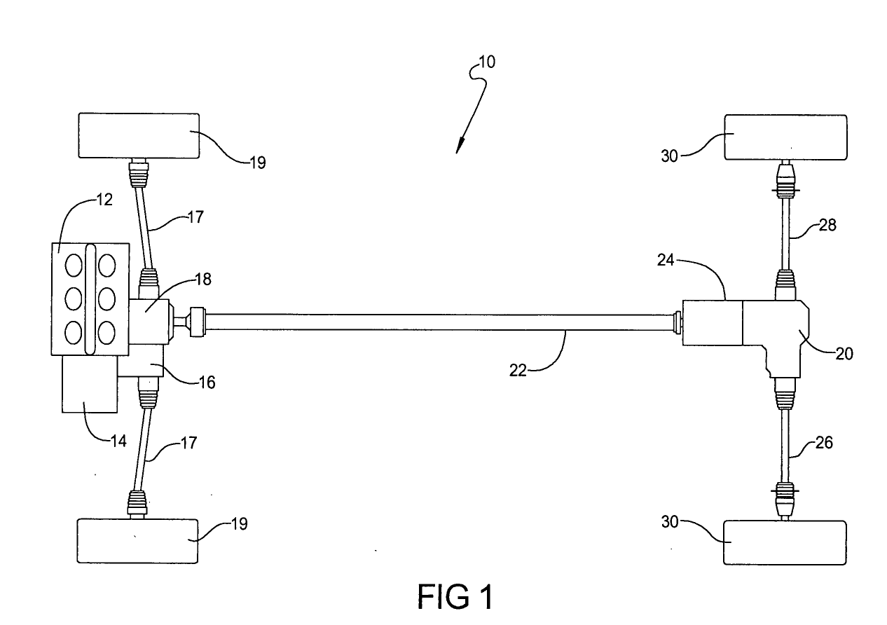

With reference to FIG. 1, an all-wheel drive or four-wheel drive motor vehicle powertrain 10 is schematically shown. The powertrain is primarily for a front-wheel driven vehicle, however, the present invention can be used on a primary rear-wheel driven vehicle as well. The motor vehicle powertrain 10 is an all-wheel drive or four-wheel drive vehicle and is driven by power transferred from the engine 12 to a transaxle 14 which may be an automatic or manual gearbox. Power is transferred from the transaxle 14 to a front differential 16 and to a power take-off unit 18 of the driveline assembly. The front differential 16 distributes driving torque to two front axle shafts 17 for driving the front wheels 19. Power is delivered to the rear differential 20 via a propeller (prop) shaft 22 through a co-axially arranged bi-directional overrunning clutch and viscous transmission unit 24, as will be described in greater detail herein. At the rear differential 20, power is split to a left hand rear side shaft 26 and a right hand rear side shaft 28 for distribution to the rear wheels 30 of the vehicle. The front differential 16 transmits power to the left axle shaft 17 and to the right axle shaft 17. An on-demand all-wheel drive vehicle distributes power directly to the front differential 18 and to the rear differential 20 via the torque distributing device 24.

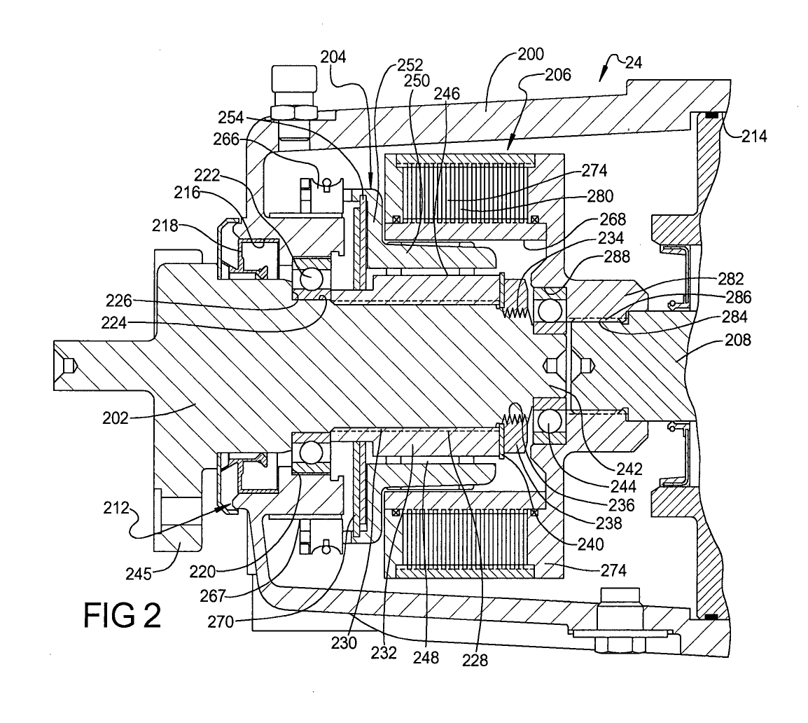

With reference to FIGS. 2-6, several different embodiments of a torque distribution device 24 including a co-axially arranged bi-directional overrunning clutch and viscous/friction transmission unit will now be described wherein like reference numerals are used amongst the various embodiments for illustrating the same or similar elements. With reference to FIG. 2, the torque distribution unit 24 is provided with a housing 200 which supports a secondary drive shaft 202 which is adapted to be bolted to, or otherwise drivingly connected to the prop shaft 22. The secondary drive shaft 202 provides driving torque to the bi-directional overrunning clutch 204 which is drivingly connected to a viscous transmission unit 206. The viscous transmission unit 206 is drivingly connected to a secondary driven shaft 208 which provides input torque to the rear differential 20.

The housing 200 of the torque distribution unit 24 is provided with a front opening portion 212 and a rear opening portion 214. The front opening portion is provided with a first recess 216 which receives a seal assembly 218 which is disposed between the secondary drive shaft 202 and the recess 216 in the front opening portion 212 of the housing 200. The front opening portion 212 also includes a shoulder 220 against which a bearing assembly 222 is seated between the front opening portion 212 and a bearing seat portion 224 provided on the secondary drive shaft 202. The secondary drive shaft 202 is provided with a shoulder portion 226 against which the bearing assembly 222 is disposed.

The secondary drive shaft 202 is provided with exterior splines 228 which are received in interior splines 230 of an inner race 232 which is mounted to the secondary driveshaft 202. The separate inner race member 232 allows easier manufacture of the drive shaft 202 and assembly of the unit 24. Also, the manufacture of the inner race member 232 is also simplified. The inner race 232 serves as an input to the bi-directional overrunning clutch 204 which will be described in greater detail herein. The secondary drive shaft 202 is provided with a threaded end portion 234 which receives an internally threaded portion 236 of a nut member 238 for axially supporting the inner race 232 on the secondary driven shaft 202. A washer 240 is optionally provided between the nut member 238 and inner race 232. The second end of the secondary drive shaft 202 is provided with a journal portion 242 which is received in a second bearing assembly 244 for supporting the second end of the secondary drive shaft 202 for rotation within the torque distribution unit 24. The first end of the secondary drive shaft 202 includes an integrally formed flange portion 245 which is adapted to be connected to the prop shaft 22. The integration of the flange portion 245 with the secondary drive shaft 202 simplifies the construction of the torque distribution device 24.

The bi-directional overrunning clutch 204 includes the inner race 232 that is fixed to the secondary drive shaft 202. As the driving member of the roller clutch, the inner race 232 has a plurality of cam surfaces 246 (FIG. 2) for engaging a respective number of rollers 248. Preferably, the cam surfaces 246 are flat, but other configurations may also be suitable.

The rollers 248 are maintained in position by a roller cage 250 that extends circumferentially around the inner race 232 and extends axially outward, forming a skirt 252 having an end ring 254. As is known in the art, the roller cage 250 includes roller openings separated by tangs. At one end of the openings and tangs is an index ring that comprises beveled keyways having semi-circular keys terminated by beveled ends and stop ends. Alternatively, to the bevel ends, the keyway could have stopped at each end and be sized sufficiently to accommodate movement of the latch as described below. The roller cage 250 also includes shoe retention legs 260 and shoe separators for retaining and positioning drag shoes 266 which are disposed adjacent to friction surface 267. The friction surface 267 is disposed directly on the housing flange portion 200a. The friction surface 267 being disposed directly on the housing eliminates the requirement for a separate component that was used to provide a friction surface in prior designs.

An outer race 268 of the bi-directional overrunning clutch 204 is formed along an interior of an axially extending surface of the viscous transmission unit 206. A latch assembly 270 is provided between the inner race 232 and skirt 252 of the bi-directional overrunning clutch 204. Latch assemblies of this type are generally known in the art as is disclosed in U.S. Pat. No. 5,782,328 which is herein incorporated by reference. The purpose of the latch 270 is to provide a latch between the inner race 232 and the roller cage 250 when the vehicle is driving at high speeds so that when the latch assembly 270 is engaged, the cage 250 is coupled to the inner race 232. At lower velocities, the latch arms are retracted by springs, as disclosed in U.S. Pat. No. 5,782,328, into a non-engaged configuration. As the velocity of the inner race 232 increases, the arms are urged outward due to centrifugal forces created by the rotation of the shaft. With sufficient centrifugal force exerted, the arms move far enough that they engage the cage 250 at keyways thus coupling the roller cage 250 to the inner race 232. When the roller cage 250 and inner race 232 are engaged, no lock-up of the bi-directional overrunning clutch 206 can occur.

The viscous transmission unit 206 provides torque metering to the rear wheels 30 when the bi-directional overrunning clutch 204 engages in response to a wheel slip. The viscous transmission unit 206 receives input torque from the outer race 268 of the bi-directional overrunning clutch 204. The outer race 268 is rotatable relative to the housing 274 of the viscous transmission unit 206.

The viscous transmission unit 206 includes a plurality of splined disks 276 which are in splined connection to the outer race 268, as well as a plurality of interleaved exterior splined plates 280 which are in splined connection to the housing 274 of the viscous transmission unit 206. A viscous fluid (not shown) is provided within the cavity housing the plates 276, 280 as is known in the art. The disks 276, 280 of the viscous transmission unit 206 are disposed radially outward of the bi-directional overrunning clutch and, therefore, provides an axially compact arrangement of the combined bi-directional overrunning clutch and viscous transmission unit. The housing 274 of the viscous transmission unit 206 is provided with a hub portion 282 having interior splines 284 which are engaged with exterior splines 286 provided on a first end of the secondary driven shaft 208 for providing driving torque from the viscous transmission unit 206 to the secondary driven shaft 208. The hub portion 282 of the housing 274 of the viscous transmission unit 206 is provided with a recessed journal portion 288 for receiving bearing assembly 244 which receives the second end of the secondary driveshaft 202. The torque distribution unit 24 can be mounted to the rear differential 20 as illustrated in FIG. 1 with the secondary driven shaft 208 providing an input to the rear differential 20.

During assembly of the torque distribution unit 24, the bearing assembly 222 is inserted into the housing 200 in position adjacent to the shoulder 220. In addition, the seal 218 is inserted in the recess 216 provided in the front opening 212 of the housing 200. Secondary drive shaft 202 is then inserted into the seal 218 and bearing 222 until the bearing 222 is received on the bearing seat portion 224 of the secondary drive shaft 202. The inner race 232 and roller cage 250 are then inserted along with the high speed latch 270 and drag shoes 266, into the rear opening portion 214 of the housing 200. The inner race 232 is engaged with the exterior splines 228 of the secondary drive shaft 202 and the drag shoes 266 are disposed around the friction surface 267 and a garter spring 269 is then assembled around the drag shoes 266 for applying a spring biasing force to the drag shoes 266. The nut member 238 and washer 240 are then installed on the threaded end portion 234 of the secondary drive shaft 202 for securing the inner race 232 in place. The bearing 244 is then inserted through the rear opening portion 214 of the housing 200 and is engaged on the end portion 242 of the secondary drive shaft 202. The viscous transmission unit 206 is then inserted into the rear opening portion 214 of the housing 200 and installed so that the bearing 244 is received within the recess portion 288 of the hub 282. The exterior splines 286 of the secondary driven shaft 208 are engaged with the interior splines 284 of the hub portion 282 of the viscous transmission unit 206.

In operation, the rear differential is designed to have a smaller gear ratio than the front differential so that during normal operation (without wheel slip) the secondary drive shaft 202 is rotated relatively slower than the secondary driven shaft 208 so that the outer race 268 is able to overrun without causing any lockup of the bi-directional overrunning clutch 206. However, during an instance of wheel slip, such as the front wheels slipping due to an icy road surface, the secondary drive shaft 202 will tend to rotate faster than the secondary driven shaft 208 thus causing lockup of the bi-directional overrunning clutch 204 which will then distribute torque to the viscous transmission unit 206 which will meter distribution of the torque to the rear wheels through the viscous coupling.

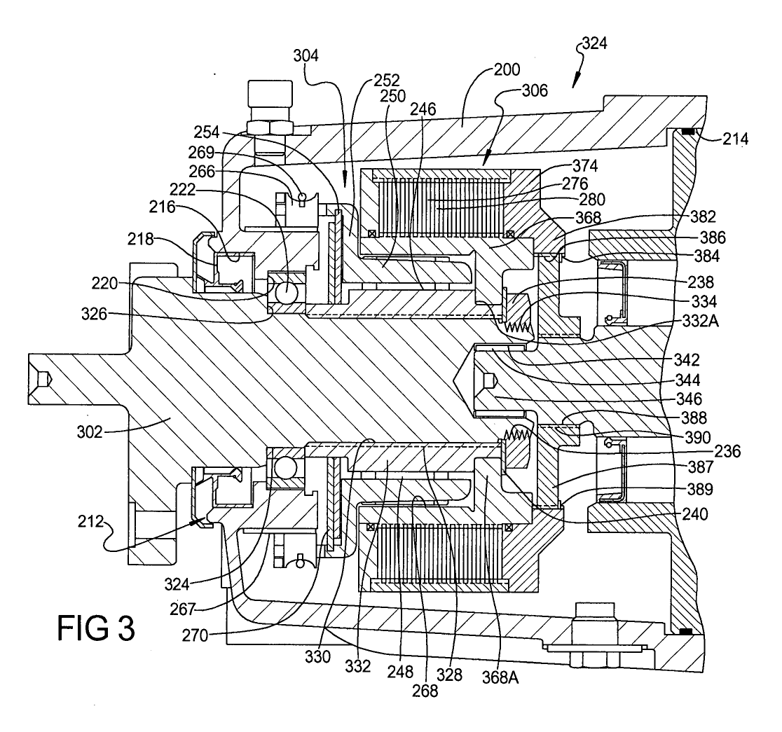

With reference to FIG. 3, a second embodiment of the torque distribution unit 324 will now be described wherein the same reference numerals are utilized for designating the same or similar elements as described with respect to the embodiment of FIG. 2. Torque distribution unit 324 is provided with a secondary drive shaft 302 which includes an integral flange portion 302A that is adapted to be bolted to, or otherwise drivingly connected to the prop shaft 22. The secondary drive shaft 302 provides driving torque to the bi-directional overrunning clutch 304 which is drivingly connected to a viscous transmission unit 306. The viscous transmission unit 306 is drivingly connected to a secondary driven shaft 308 which provides input torque to the rear differential 20.

The housing 200 of the torque distribution unit 324 is provided with a front opening portion 212 and a rear opening portion 214. The front opening portion 212 is provided with a first recess 216 which receives a seal assembly 218 which is disposed between the secondary drive shaft 302 and the recess 216 in the front opening portion 212 of the housing 200. The front opening portion 212 also includes a shoulder 220 against which a bearing assembly 222 is seated between the front opening portion 212 and a bearing seat portion 324 provided on the secondary drive shaft 302. The secondary drive shaft 302 is provided with a shoulder portion 326 against which the bearing assembly 222 is disposed. The secondary drive shaft 302 is provided with exterior splines 328 which are received in interior splines 330 of an inner race 332 which is mounted to the secondary drive shaft 302. The inner race 332 serves as an input to the bi-directional overrunning clutch 304 which will be described in greater detail herein. The secondary drive shaft 302 is provided with a threaded end portion 334 which receives an internally threaded portion 236 of a nut member 238 for axially supporting the inner race 332 on the secondary driven shaft 302. A washer 240 is optionally provided between the nut member 238 and the inner race 332. The second end of the secondary drive shaft 302 is provided with an internal bore providing a journal portion 342 which supports a needle bearing assembly 344 which receives a first end portion 346 of the secondary driven shaft 308 for rotatably supporting the end of the secondary drive shaft 302 for rotation within the torque distribution unit 324.

The bi-directional overrunning clutch 304 includes the inner race 332 that is fixed to the secondary drive shaft 302. As the driving member of the roller clutch, the inner race 332 has a plurality of cam surfaces for engaging a respective number of rollers 248. Preferably, the cam surfaces 246 are flat, but other configurations may also be suitable.

The rollers 248 are maintained in position by a roller cage 250 that extends circumferentially around the inner race 332 and extends radially outward, forming a skirt 252 having an end ring 254. As is known in the art, the roller cage 250 includes roller openings separated by tangs. At one end of the openings and tangs is an index ring that comprises beveled keyways having semi-circular keys terminated by beveled ends and stop ends. Alternatively, to the bevel ends, the keyway could have stops at each end and be sized sufficiently to accommodate movement of the latch as described below. The cage 250 also includes shoe retention legs 260 and shoe separators for retaining and positioning drag shoes 266 which are disposed in friction contact with friction surface 267. An outer race 268 of the bi-directional overrunning clutch 304 is formed along an interior of an axially extending surface of the viscous transmission unit 306. A latch assembly 270 is provided between the inner race 332 and skirt 252 of the bi-directional overrunning clutch 304.

The viscous transmission unit 306 provides torque metering to the rear wheels 30 when the bi-directional overrunning clutch engages in response to a wheel slip. The viscous transmission unit 306 receives input torque from the outer race 268 of the bi-directional overrunning clutch 304. The outer race 268 is rotatable relative to the housing 374 of the viscous transmission unit 306.

The viscous transmission unit 306 includes a plurality of internally splined disks 276 which are in splined connection to the outer race 268, as well as a plurality of interleaved exterior splined disks 280 which are in splined connection to the housing 374 of the viscous transmission unit 306. A viscous fluid (not shown) is provided within the cavity housing the plates 276, 280 as is known in the art. The housing 374 of the viscous transmission unit 306 is provided with a hub portion 382 having interior splines 384 which are engaged with exterior splines 386 provided on an intermediate hub portion 387 which in turn is provided with interior splines 38 which are engaged with exterior splines 390 provided on a first end of the secondary driven shaft 308. The outer race 268 is connected to a viscous transmission unit housing portion 368 which is provided with a radially inwardly extending hub portion 368A which is rotatably received in a recess portion 332A of the inner race 332 and retained in place by washer 240. The intermediate hub portion 387 of the viscous transmission unit 306 is retained in place by a clamp ring 389 received in an annular groove within the hub portion 382. The torque distribution unit 324 can be mounted to the rear differential 20, as illustrated in FIG. 1 with the secondary driven shaft 208 providing an input to the rear differential 20.

During assembly of the torque distribution unit 324, the bearing 222 is inserted into the housing 200 in position adjacent to the shoulder 220. In addition, the seal 218 is inserted in the recess 216 provided in the front opening portion 212 of the housing 200. The secondary drive shaft is then inserted into the seal 218 and the bearing 222 until the bearing 222 is received on the bearing seat portion 324 of the secondary drive shaft 302. The inner race 332 and roller cage 250 are then inserted along with the high speed latch 270 and drag shoes 266, into the rear opening portion 214 of the housing 200. The inner race 332 is engaged with the exterior splines 328 of the secondary drive shaft 302 and the drag shoes 266 are disposed around the friction surface 267 and a garter spring 269 is then assembled around the drag shoes 266 for applying a spring biasing force to the drag shoes 266. The viscous transmission unit 306 is then inserted into the opening 214 in housing 200, and the inner hub portion 368A of the inner housing portion 368 of the viscous transmission unit 306 is received on the recessed journal portion 332A of the inner race 332 and a washer 240 and nut member 238 are fastened onto the exterior threaded portion 334 of the secondary drive shaft 302. The intermediate hub portion 287 is then inserted so that the exterior splines 386 engage the interior splines 384 of the hub portion 382 and the clip member 389 is inserted in order to retain the intermediate hub portion 387 in place. The exterior splines 390 of the secondary driven shaft 308 are engaged with the interior splines 388 of the intermediate hub portion 387.

In operation, the overall function of the torque distribution unit 324 is the same as the torque distribution unit 24, as described above, with reference to FIG. 2.

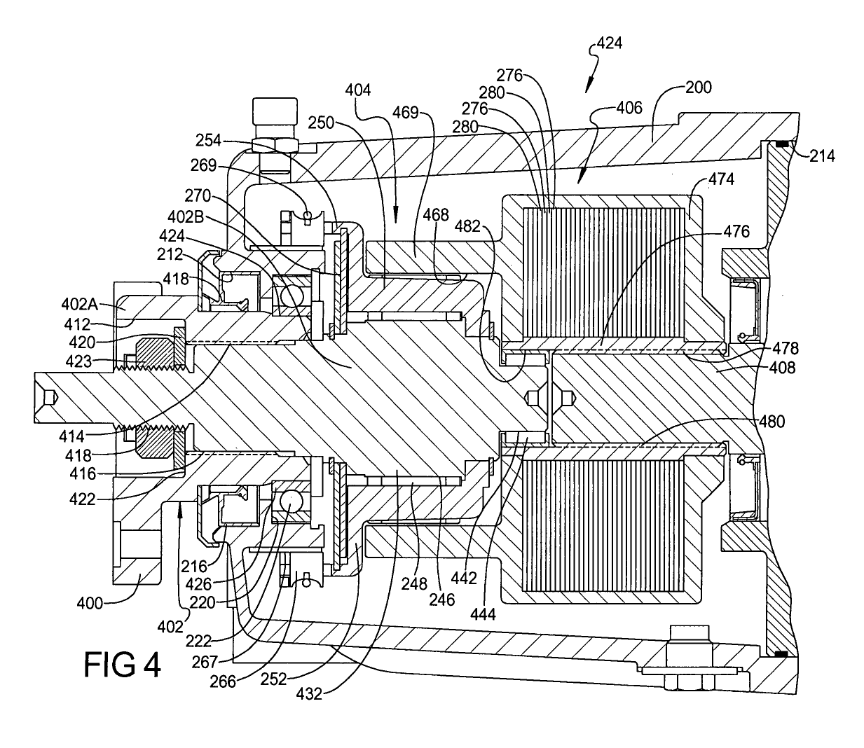

With reference to FIG. 4, a third embodiment of the torque distribution unit 424 will now be described wherein the same reference numerals are utilized for designating the same or similar elements as described with respect to the embodiment of FIG. 2. The torque distribution unit 424 is provided with a secondary drive shaft assembly 402 which is adapted to be bolted to, or otherwise drivingly connected to, the prop shaft 22. The secondary drive shaft assembly 402 provides driving torque to the bi-directional overrunning clutch 404 which is drivingly connected to a viscous transmission unit 406. The viscous transmission unit 406 is drivingly connected to a secondary driven shaft 408 which provides input torque to the rear differential 20.

The housing 200 of the torque distribution unit 424 is provided with a front opening portion 212 and a rear opening portion 214. The front opening portion is provided with a first recess 216 which receives a seal assembly 218 which is disposed between the secondary drive shaft assembly 402 and the recess 216 in the front opening portion 212 of the housing 200. The front opening portion 212 also includes a shoulder 220 against which a bearing assembly 222 is seated between the front opening portion 212 and a bearing seat portion 424 provided on the secondary drive shaft assembly 402. The secondary drive shaft assembly 402 is provided with a shoulder portion 426 against which the bearing assembly 222 is disposed.

The secondary drive shaft assembly 402 includes a first shaft portion 402A having a flange portion 400 adapted for connection to the prop shaft 22 and an interior bore portion 412 for receiving a second shaft portion 402B therein. The first shaft portion 402A of the secondary drive shaft assembly 402 includes interior splines 414 which are engaged by exterior splines 416 provided on the second shaft portion 402B. Second shaft portion 402B includes an externally threaded forward end 418 which receives a washer 420 which abuts against a shoulder 422 within the internal bore portion 412 of the first shaft portion 402A. A nut member 423 is threadedly engaged with the externally threaded forward end 418 of the second input shaft portion 402B for engaging the first shaft portion 402A and second shaft portion 402B in an assembled co-rotating condition.

The second shaft portion 402B of the secondary drive shaft assembly 402 includes an inner race portion 432 integrally formed therewith. The inner race 432 serves as an input to the bi-directionally overrunning clutch 404 which will be described in greater detail. The secondary drive shaft 402B is provided with a journal portion 442 which is received in a needle bearing assembly 444 for supporting the second end of the secondary drive shaft assembly 402 for rotation with the torque distribution unit 424. The bi-directional overrunning clutch 404 includes the inner race 432 which is integrally formed with the second shaft portion 402B of the secondary drive shaft assembly 402. As the driving member of the roller clutch, the inner race 432 has a plurality of cam surfaces 246 for engaging a respective number of rollers 248. Preferably, the cam surfaces 246 are flat, but other configurations may also be suitable.

The rollers 248 are maintained in position by a roller cage 250 that extends circumferentially around the inner race 432 and extends axially outward, forming a skirt 252 having an end ring 254. The roller cage 250 includes shoe retention legs 260 and shoe separators for retaining and positioning drag shoes 266 which are disposed adjacent to friction surface 267. A latch assembly 270 is provided between the inner race 432 and skirt 252 of the bi-directional overrunning clutch 404. Latch assemblies of this type are generally known in the art.

An outer race 468 of the bi-directional overrunning clutch 404 is formed along an extension arm 469 of the viscous transmission unit 406. The viscous transmission unit 406 provides torque metering to the rear wheels 30 when the bi-directional overrunning clutch 404 engages in response to a wheel slip. The viscous transmission unit 406 receives input torque from the outer race 468 of the bi-directional overrunning clutch 404. The outer race 468 is fixedly attached to the housing 474 of the viscous transmission unit 406. The viscous transmission unit 406 includes a plurality of externally splined disks 276 which are in spline connection to the housing 474, as well as the plurality of interleaved interior splined plates 280 which are in splined connection to an interior housing portion 476. The interior housing portion 476 has interior splines 478 which are engaged with exterior splines 480 provided on a first end of the secondary driven shaft 408 for providing driving torque from the viscous transmission unit 406 to the secondary driven shaft 408. The interior housing portion 476 is provided with a recessed seat portion 482 at a forward end thereof for receiving the needle bearing assembly 444 which receives the second end of the secondary drive shaft assembly 402.

During assembly of the torque distribution unit, the bearings 222 are inserted into the housing 200 and positioned adjacent to the shoulder 220. In addition, the seal 218 is inserted in the recess 216 provided in the front opening 212 of the housing 200. The first shaft portion 402A of the secondary drive shaft assembly 402 is then inserted into the seal 218 and bearing 222 until the bearing 222 is received on the bearing seat 424 of the first shaft portion 402A. The second shaft portion 402B of the secondary drive shaft 402 is then inserted through the second opening 214 in housing 200 and further inserted into the bore portion 412 of the first shaft portion 402A so that the exterior splines 416 of the second shaft portion 402B engage the interior splines 414 of the first shaft portion 402A. The washer 420 is then slid over the threaded forward end 418 of the second shaft portion 402B and the nut member 423 is threadedly engaged with the threaded forward end 418 of the second shaft portion 402B in order to secure the second shaft portion 402B to the first shaft portion 402A in order to form the secondary drive shaft assembly 402. It should be noted that the roller cage 250, high speed latch 270, and drag shoes 266 are inserted along with the second shaft portion 402B so that the drag shoes 266 are disposed along the friction surface 267 while the second shaft portion 402B is inserted into the first shaft portion 402A. The needle bearing assembly 444 is then disposed around the journal portion 442 at the end of the second shaft portion 402B and the viscous transmission unit 406 is inserted through the second opening 214 in housing 200 so that the needle bearing assembly 444 is received in the recessed portion 482 of the viscous transmission unit 406 and so that the arm portion 469 of the housing 474 supports the outer race 468 of the bi-directional overrunning clutch 404 in a radial position relative to the rollers 248. The exterior splines 480 of the secondary driven shaft 408 are engaged with the interior splines 478 of the inner housing portion 476 of the viscous transmission unit 406.

The operation of the torque distribution unit 424 is the same as the operation of the torque distribution unit 24, as described above.

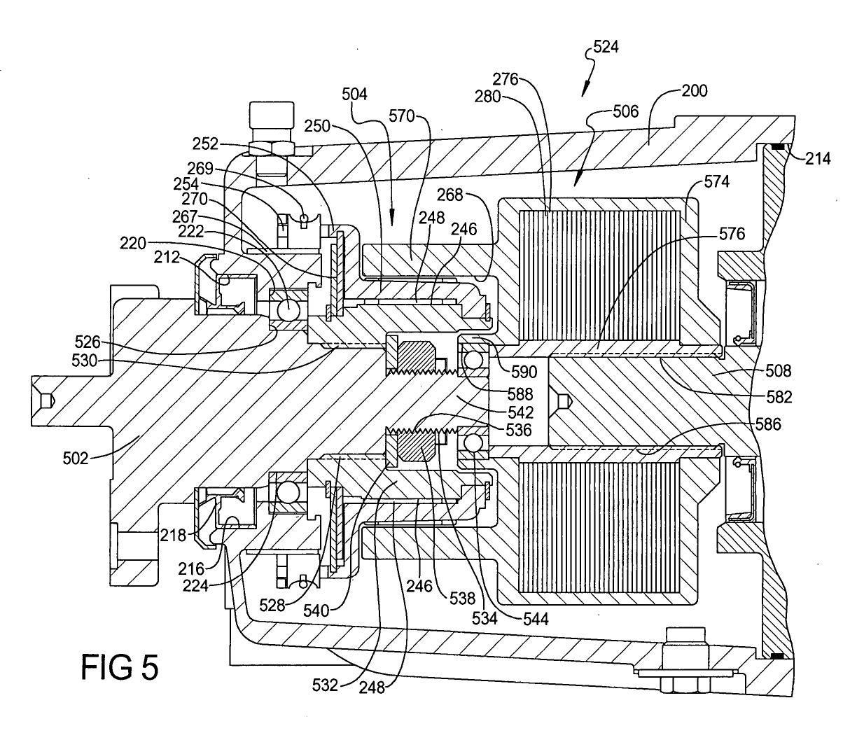

With reference to FIG. 5, a fourth embodiment of the torque distribution unit 524 will now be described wherein the same reference numerals are utilized for designating the same or similar elements as described with respect to the embodiment of FIG. 2. The torque distribution unit 524 is provided with a secondary drive shaft 502 which is adapted to be bolted to, or otherwise drivingly connected to, the prop shaft 22. A secondary drive shaft 502 provides drive torque to the bi-direction overrunning clutch 504 which is drivingly connected to a viscous transmission unit 506. The viscous transmission unit is drivingly connected to a secondary driven shaft 508 which provides input torque to the rear differential 20.

The housing 200 of the torque distribution unit 524 is provided with a front opening portion 212 and a rear opening portion 214. The front opening portion is provided with a first recess 216 which receives a seal assembly 218 which is disposed between the secondary drive shaft 502 and the recess 216 in the front opening portion 212 of the housing 200. The front opening portion also includes a shoulder 220 against which a bearing assembly 222 is seated between the front opening portion 212 and a bearing seat portion 224 provided on the secondary drive shaft 502. The secondary drive shaft 502 is provided with a shoulder portion 526 against which the bearing assembly 222 is disposed.

The secondary drive shaft 502 is provided with exterior splines 528 which are received in interior splines 530 of an inner race 532 which is mounted to the secondary drive shaft 502. The inner race 532 serves as an input to the bi-directional overrunning clutch 504 which will be described in greater detail herein. The secondary drive shaft 502 is provided with a threaded rear end 534 which receives an internally threaded portion 536 of a nut member 538 for axially supporting the inner race 532 on the secondary driven shaft 502. A washer 540 is optionally provided between the nut member 538 and the inner race 532. The rear end of the secondary drive shaft 502 is also provided with a journal portion 542 which is received in a second bearing assembly 544 for supporting the second end of the secondary drive shaft 502 for rotation within the torque distribution unit 524.

The bi-directional overrunning clutch 504 includes the inner race 532 that is fixed to the secondary drive shaft 502. As the driving member of the roller clutch, the inner race 532 has a plurality of cam surfaces 246 for engaging a respective number of rollers 248. Preferably, the cam surfaces 246 are flat, but other configurations may also be suitable.

The rollers 248 are maintained in position by a roller cage 250 that extends circumferentially around the inner race 532 and extends axially outward forming a skirt 252 having an end ring 254. The roller cage 250 also includes shoe retention legs and shoe separators for retaining and positioning drag shoes 266 which are disposed adjacent to friction surface 267.

An outer race 268 of the bi-directional overrunning clutch 504 is formed along an interior surface of an axially extending arm portion 570 of the viscous transmission unit 506. A latch assembly 270 is provided between the inner race 532 and skirt 252 of the bi-directional overrunning clutch 504. Latch assemblies of this type are generally known in the art.

The viscous transmission unit 506 provides torque metering to the rear wheels 30 when the bi-directional overrunning clutch 504 engages in response to a wheel slip. The viscous transmission unit 506 receives input torque from the outer race 268 of the bi-directional overrunning clutch 504. The outer race 268 is affixed to the housing 574 of the viscous transmission unit 506.

The viscous transmission unit 506 includes a plurality of externally splined disks 276 which are in splined connection to the internal splines of the housing 574, as well as a plurality of interleaved interior splined disks 280 which are in splined connection to the inner housing portion 576 of the viscous transmission unit 506. The inner housing portion 576 is rotatable relative to the main housing portion 574. A viscous fluid (not shown) is provided within the cavity housing the plates 276, 280, as is known in the art. The inner housing portion 576 of the viscous transmission unit 506 is provided with interior splines 582 which are engaged with exterior splines 586 provided on a first end of the secondary driven shaft 508 for providing driving torque from the viscous transmission unit 506 to the secondary driven shaft 508. The housing 574 of the viscous transmission unit includes a recessed portion 588 on an axially extending hub portion 590 for receiving the second bearing 544 which receives the second end of the secondary drive shaft 502.

During assembly of the torque distribution unit 524, the bearing 222 is inserted into the housing 200 in position adjacent to the shoulder 220. In addition, the seal 218 is inserted in the recess 216 provided in the front opening 212 of the housing 200. Secondary drive shaft 502 is then inserted into the seal 218 and bearing 222 until the bearing 222 is received on the bearing seat 224 of the secondary drive shaft 502. The inner race 532 and roller cage 250 are then inserted along with the high speed latch 270 and drag shoes 266 into the rear opening portion 214 of the housing 200. The interior splines 530 of the inner race 532 are engaged with the exterior splines 528 of the secondary drive shaft 502 and the drag shoes 266 are disposed around the friction surface 267. The garter spring 269 is then assembled around the drag shoes for applying a spring biasing force to the drag shoes 266. The nut member 538 and washer 540 are then installed on the threaded rear end 534 of the secondary drive shaft 502 for securing the inner race 532 in place. The bearing 544 is then inserted into the rear opening portion 214 of the housing 200 and is engaged on the end portion 542 of the secondary drive shaft 502. The viscous transmission unit 506 is then inserted into the rear opening portion 214 of the housing 200 and installed so that the bearing 544 is received within the recessed portion 588 of the axially extending hub 590 of the viscous transmission unit 506.

The exterior splines 586 of the secondary driven shaft 508 are engaged with the interior splines 582 of the inner housing portion 576 of the viscous transmission unit 506.

The operation of the torque distribution unit 524 is the same as the torque distribution unit 24, as described above.

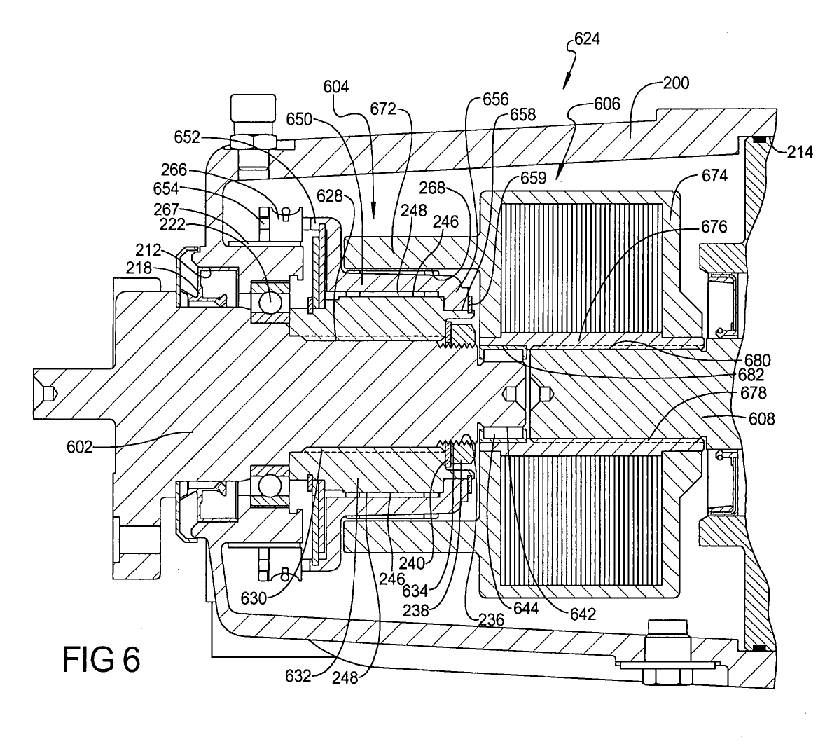

With reference to FIG. 6, a fifth embodiment of the torque distribution unit 624 will now be described wherein the same reference numerals are utilized for designating the same or similar element as described with respect to the embodiment of FIG. 2. The torque distribution unit 624 is provided with a secondary drive shaft 602 which is adapted to be bolted to, or otherwise drivingly connected to, the prop shaft 22. The secondary drive shaft 602 provides driving torque to the bi-directional overrunning clutch 604 which is drivingly connected to a viscous transmission unit 606. The viscous transmission unit 606 is drivingly connected to a secondary driven shaft 608 which provides input torque to the rear differential 20.

In the embodiment of FIG. 6, the secondary drive shaft 602 is supported by a bearing 222 in the same manner as described with respect to the torque distribution unit 24 shown in FIG. 2. In addition, the seal 218 engages the secondary drive shaft 602 in the same manner as described above with respect to the torque distribution unit 24. Accordingly, the details of these arrangements will not be described with respect to this embodiment. The secondary drive shaft 602 is provided with exterior splines 628 which are received in interior splines 630 of an inner race 632 which is mounted to the secondary drive shaft 602. The inner race 632 serves as an input to the bi-directional overrunning clutch 604 which will be described in greater detail. The secondary drive shaft 602 is provided with a threaded rear end 634 which receives an internally threaded portion 236 of a nut member 238 for axially supporting the inner race 632 on the secondary driven shaft 602. A washer 240 is optionally provided between the nut member 238 and inner race 632. The rear end of the secondary drive shaft 602 is also provided with a journal portion 642 which is received in a needled bearing assembly 644 for supporting the rear end of the secondary drive shaft 602 for rotation within the torque distribution unit 624.

The bi-directional overrunning clutch 604 includes the inner race 632 that is fixed to the secondary drive shaft 602. As the driving member of the roller clutch, the inner race 632 has a plurality of cam surfaces 246 for engaging a respective number of rollers 248. Preferably, the cam surfaces 246 are flat, but other configurations may also be suitable.

The rollers 248 are maintained in position by a roller cage 650 that extends circumferentially around the inner race 632 and extends axially outward forming a skirt 652 having an end ring 654. The roller cage 650 also includes a radially inwardly extending portion 656 which rotatably engages a recessed annular portion 658 provided on the inner race 632. A clip 659 is provided for retaining the roller cage 650 for inhibiting axial movement of the roller cage 650 relative to the inner race 632. The roller cage 650 also includes shoe retention legs and shoe separators for retaining and positioning drag shoes 266 which are disposed adjacent to friction surface 267.

An outer race 268 of the bi-directional overrunning clutch 604 is formed along an interior of an axially extending arm portion 672 which extends from the housing 674 of the viscous transmission unit 606. A latch assembly 270 is provided between the inner race 632 and skirt 652 of the bi-directional overrunning clutch 604. Latch assemblies of this type are generally known in the art.

The viscous transmission unit 606 provides torque metering to the rear wheels 30 when the bi-directional overrunning clutch 604 engages in response to a wheel slip. The viscous transmission unit 606 receives input torque from the outer race 268 of the bi-directional overrunning clutch 604. The outer race 268 is fixed to the housing 674 of the viscous transmission unit 606.

The viscous transmission unit 606 includes a plurality of exterior splined disks 276 which are in splined connection to the housing 674, as well as a plurality of interleaved interior splined disks 280 which are in splined connection to an inner housing portion 676 of the viscous transmission unit 606. A viscous fluid (not shown) is provided within the cavity housing the plates 276, 280 as is known in the art. The inner housing portion 676 of the viscous transmission unit 606 is provided with interior splines 678 which engage exterior splines 680 of secondary driven shaft 608 for providing driving torque from the viscous transmission unit 606 to the secondary driven shaft 608. The inner housing portion 676 of the viscous transmission unit 606 is provided with a recess portion 682 which receives the needle bearing assembly 644 which receives the rear end of the secondary drive shaft 602.

Assembly of the torque distribution unit 624 utilizes essentially the same assembly steps as described with respect to the torque distribution unit 24 show in FIG. 2 with the exception that the radially inwardly extending portion 256 of the roller cage 250 is engaged to the inner race 632 and secured in place by the clip 659 prior to assembly within the housing 200.

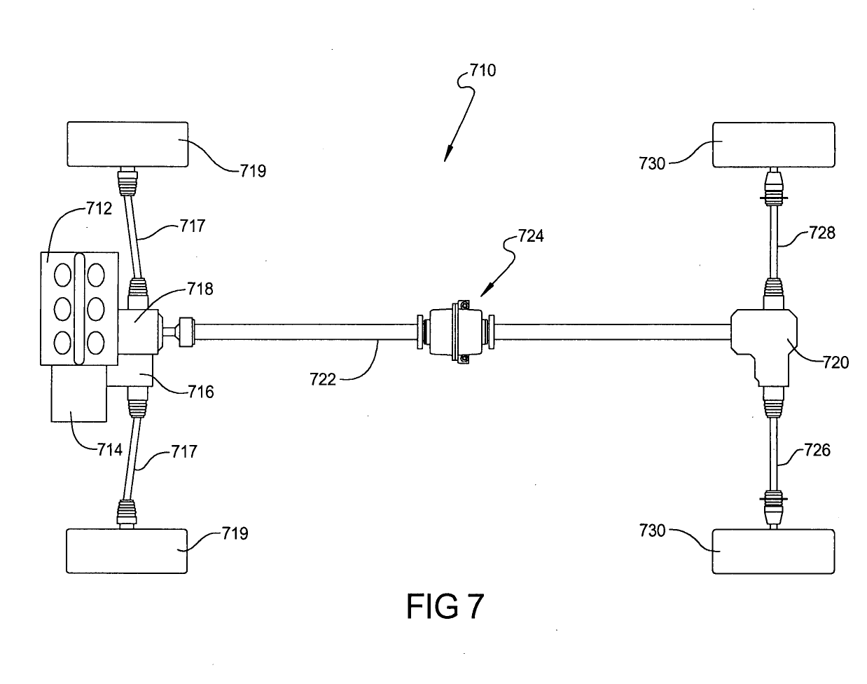

With reference to FIG. 7, an all-wheel drive or four-wheel drive motor vehicle powertrain 710 is schematically shown. The powertrain is primarily for a front-wheel driven vehicle, however, the present invention can be used on a primary rear-wheel driven vehicle as well. The motor vehicle powertrain 710 is an all-wheel drive or four-wheel drive vehicle and is driven by power transferred from the engine 712 to a transaxle 714 which may be an automatic or manual gearbox. Power is transferred from the transaxle 714 to a front differential 716 and through to a power take-off unit 718 of the driveline assembly. The front differential 716 distributes driving torque to two front axle shafts 717 for driving the front wheels 719. Power is delivered to the rear differential 720 via a propeller shaft 722 through a mid-mounted co-axially arranged bi-directional overrunning clutch and viscous transmission unit 724, as will be described in greater detail herein. At the rear differential 720, power is split to a left hand rear side shaft 726 and a right hand rear side shaft 728 for distribution to the rear wheels 730 of the vehicle. The front differential 718 transmits power to the left axle shaft 732 and to the right axle shaft 734. An on-demand all-wheel drive vehicle distributes power to both the rear differential 720 and the front differential 718 via the torque distributing device 724. It should be noted that the bi-directional overrunning clutch and viscous transmission unit 724 can be connected to the prop shaft sections using universal or constant velocity joints or by splined connection. In addition, the housing can be mounted to the vehicle using a vibration isolation mount.

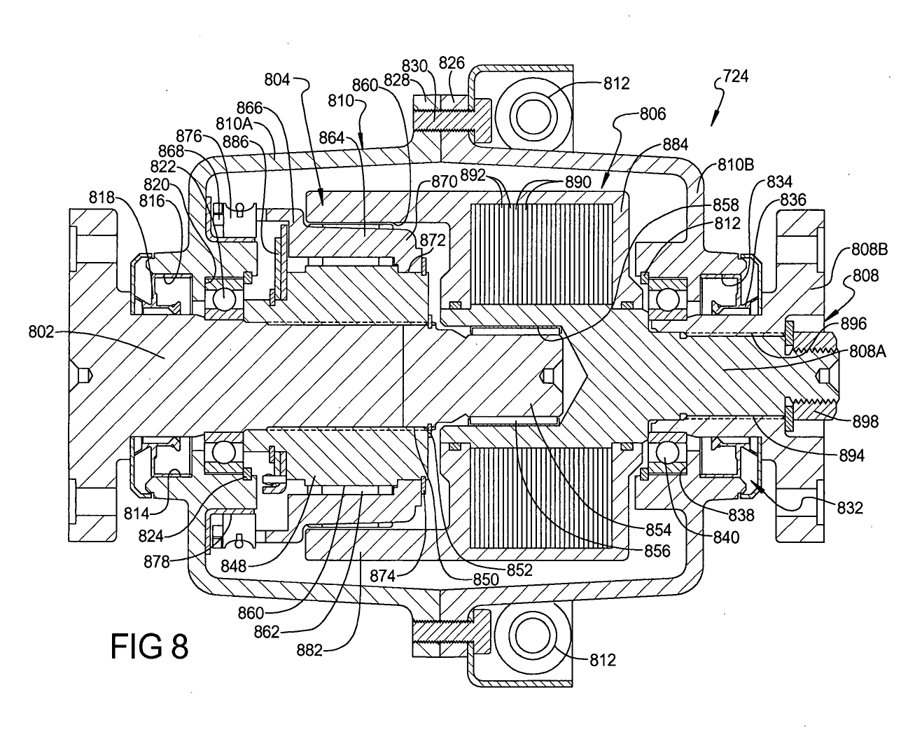

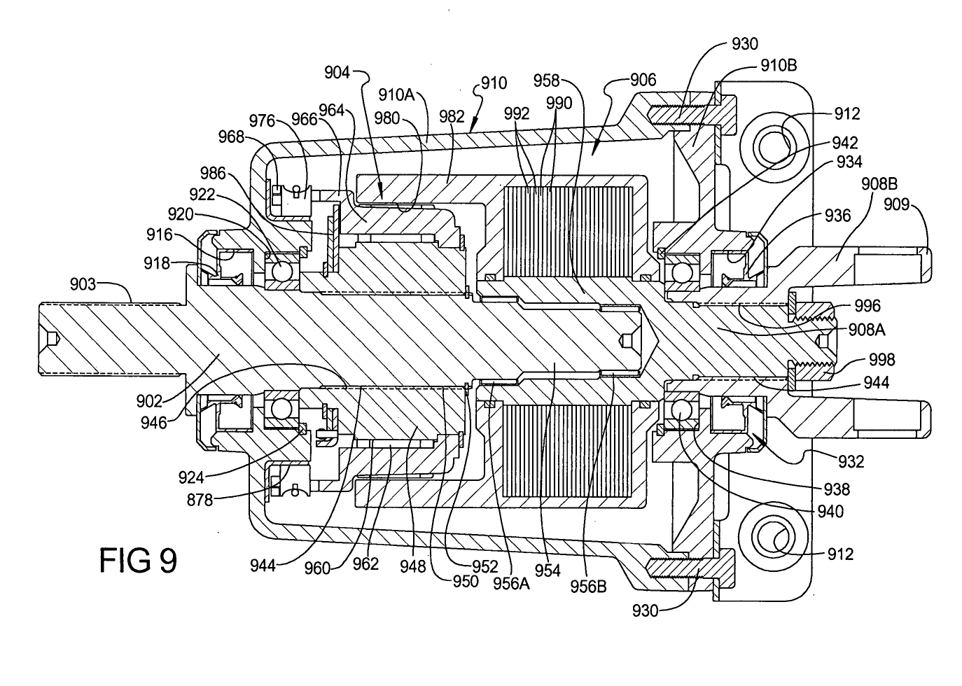

With reference to FIGS. 8 and 9, the mid mounted torque distribution device 724 will now be described including a coaxially arranged bi-directional overrunning clutch and viscous transmission unit. Specifically, with reference to FIG. 8, the torque distribution unit 724 is provided with a secondary drive shaft 802 which is adapted to be bolted to, or otherwise drivingly connected to the prop shaft 22. The secondary drive shaft 802 provides driving torque to the bi-directional overrunning clutch 804 which is drivingly connected to a viscous transmission unit 806. The viscous transmission unit 806 is drivingly connected to a secondary driven shaft assembly 808 which is adapted to be bolted to, or otherwise drivingly connected to, a secondary prop shaft portion which provides input torque to the rear differential 720. The mid-mounted torque distribution device 724 is provided with a housing 810 which is provided with mounting features 812 for mounting the housing 810 to the underside of a vehicle. The housing 810 includes a front housing portion 810A and a rear housing portion 810B. The front housing portion 810A includes a front opening 814 having a first recessed area 816 for receiving a seal 818. The front opening 814 also includes a shoulder 820 for receiving a bearing assembly 822 thereagainst. Bearing assembly 822 is secured in place by a retainer ring 824.

The rear housing portion 810B is provided at a forward end thereof with a radial flange 826 which is secured to a flange 828 provided at the rear of the front housing portion 810A by threaded fasteners 830 or other known fastening means. The rear housing portion 810B is provided with a rear opening 832 which is provided with a first recess 834 for receiving a seal 836. A shoulder 838 is provided in the opening 832 for receiving a bearing assembly 840 thereagainst. A retainer ring 842 is provided for retaining the bearing assembly 840 in place.

The secondary drive shaft 802 is provided with exterior splines 844 which are received in interior splines 846 of an inner race 848 which is mounted to the secondary drive shaft 802. The inner race 848 serves as an input to the bi-directional overrunning clutch 804 which will be described in greater detail herein. The secondary drive shaft 802 is provided with a recessed annular groove 850 for receiving a retainer ring 852 for retaining the inner race 840 on the secondary drive shaft 802. The secondary drive shaft 802 has a rear end portion 854 which is received in a needle bearing assembly 856 which, in turn, is received in an internal bore 858 provided in the forward end of the secondary driven shaft 808.

The bi-directional overrunning clutch 804 includes the inner race 848 that is fixed to the secondary drive shaft 802. As the driving member of the roller clutch, the inner race 848 has a plurality of cam surfaces 860 for engaging a respective number of rollers 862. Preferably, the cam surfaces 860 are flat, but other configurations may also be suitable.

The rollers 862 are maintained in position by a roller cage 864 that extends circumferentially around the inner race 848 and extends radially outward, forming a skirt 866 having an end ring 868. As is known in the art, the roller cage 864 includes roller openings separated by tangs. At a rear end of the roller cage, a radially inwardly extending hub portion 870 is rotatably received on a recess 872 provided on the outer surface of the inner race 848. A retainer ring 874 secures the roller cage 864 from moving axially relative to the inner race 848. A roller cage 864 also includes shoe retention legs for retaining and positioning drag shoes 876 which are disposed adjacent to friction surface 878. An outer race 880 of the bi-directional overrunning clutch 804 is formed along an interior surface of a cylindrical extension 882 of a housing 884 of the viscous transmission unit 806. A latch assembly 886 is provided between the inner race 848 and the roller cage 864 of the bi-directional overrunning clutch 804. Latch assemblies of this type are generally known in the art. The purpose of the high speed latch 886 is to provide a latch between the inner race 848 and the roller cage 864 when the vehicle is driving at high speeds.

The viscous transmission unit 806 provides torque metering to the rear wheels 730 when the bi-directional overrunning clutch 804 engages in response to a wheel slip. The viscous transmission unit 806 receives input torque from the outer race 880 of the bi-directional overrunning clutch 804. The housing 884 of the viscous transmission unit 806 is rotatable relative to the secondary driven shaft 808. The viscous transmission unit 806 includes a plurality of splined disks 890 which are in splined connection to the housing 884, as well as a plurality of interleaved splined disks 892 which are in splined connection to the secondary driven shaft 808. A viscous fluid (not shown) is provided within the cavity housing the plates 890, 892, as is known in the art. The housing 884 of the viscous transmission unit 806 transmits torque to the disks 890 which, via the viscous fluid, transmits torque to the disks 892 which thereby transmit torque to the secondary driven shaft 808. The secondary driven shaft assembly 808 is supported by the bearing 840 and is received within the seal 836. The secondary driven shaft assembly includes a first shaft portion 808A having external splines 894 which engage internal splines 896 provided in an internal passage of the rear secondary shaft portion 808B. The rear end of the forward shaft portion 808A is provided with a threaded end for receiving a nut member 898 for securing the front and rear shaft portions 808A, 808B of the secondary drive shaft assembly 808.

With reference to FIG. 9, a torque distribution unit 924 is provided with a secondary drive shaft 902 which includes external splines 903 for being drivingly connected to the prop shaft 722. The secondary drive shaft 902 provides driving torque to the bi-directional overrunning clutch 904 which is drivingly connected to a viscous transmission unit 906. The viscous transmission unit 906 is drivingly connected to a secondary driven shaft assembly 908 which includes a yoke portion 909 adapted to be drivingly connected to, a secondary prop shaft portion which provides input torque to the rear differential 720. The mid-mounted torque distribution device 924 is provided with a housing 910 which is provided with mounting features 912 for mounting the housing 910 to the underside of a vehicle. The housing 910 includes a front housing portion 910A and a rear housing portion 910B. The front housing portion 910A includes a front opening portion 914 having a first recessed area 916 for receiving a seal 918. The front opening 914 also includes a shoulder 920 for receiving a bearing assembly 922 there against. Bearing assembly 922 is secured in place by a retainer ring 924.

The rear housing portion 910B is secured to a flange 928 provided at the rear of the front housing portion 910A by threaded fasteners 930 or by other known fastening means. The rear housing portion 910B is provided with an opening portion 932 which is provided with a first recessed portion 934 for receiving a seal 936. A shoulder portion 938 is provided in the opening 932 for receiving a bearing assembly 940 there against. A retainer ring 942 is provided for retaining the bearing assembly 940 in place.

The secondary drive shaft 902 is provided with exterior splines 944 which are received in interior splines 946 of an inner race 948 which is mounted to the secondary drive shaft 902. The inner race 948 serves as an input to the bi-directional overrunning clutch 904 which will be described in greater detail herein. The secondary drive shaft 902 is provided with a recessed annular groove 950 for receiving a retainer ring 952 for retaining the inner race 948 on the secondary drive shaft 902. The secondary drive shaft 902 has a stepped rear end portion 954 which is received in a pair of needle bearing assemblies 956A, 956B which, in turn, are received in a stepped internal bore 958 provided in the forward end of the secondary driven shaft 908.

The bi-directional overrunning clutch 904 includes the inner race 948 that is fixed to the secondary drive shaft 902. As the driving member of the roller clutch, the inner race 948 has a plurality of cam surfaces 960 for engaging a respective number of rollers 962. Preferably, the cam surfaces 960 are flat, but other configurations may also be suitable.

The rollers 962 are maintained in position by a roller cage 964 that extends circumferentially around the inner race 948 and extends axially outward, forming a skirt 966 having an end ring 968. As is known in the art, the roller cage 964 includes roller openings separated by tangs. At a rear end of the roller cage, a radially inwardly extending hub portion 970 is rotatably received on a recess 972 provided on the outer surface of the inner race 948. A retainer ring 974 secures the roller cage 964 from moving axially relative to the inner race 948. The roller cage 964 also includes shoe retention legs for retaining and positioning drag shoes 976 which are disposed adjacent to friction surface 978. An outer race 980 of the bi-directional overrunning clutch 904 is formed along an interior surface of a cylindrical extension 982 of a housing 984 of the viscous transmission unit 906. A latch assembly 986 is provided between the inner race 948 and the roller cage 964 of the bi-directional overrunning clutch 904. Latch assemblies of this type are generally known in the art.

The viscous transmission unit 906 provides torque metering to the rear wheels 730 when the bi-directional overrunning clutch 904 engages in response to a wheel slip. The viscous transmission unit 906 receives input torque from the outer race 980 of the bi-directional overrunning clutch 904. The housing 984 of the viscous transmission unit 906 is rotatable relative to the secondary driven shaft 908. The viscous transmission unit 906 includes a plurality of splined disks 990 which are in splined connection to the housing 984, as well as a plurality of interleaved splined disks 992 which are in splined connection to the secondary driven shaft 908. A viscous fluid (not shown) is provided within the cavity housing the plates 990, 992, as is known in the art. The housing 984 of the viscous transmission unit 906 transmits torque to the disks 990 which, via the viscous fluid, transmits torque to the disk 992 which thereby transmit torque to the secondary driven shaft 908. The secondary driven shaft assembly 908 is supported by the bearing 940 and is received within the seal 936. The secondary driven shaft assembly includes a first shaft portion 908A having an external splines 994 which engage internal splines 996 provided in an internal passage of the rear secondary shaft portion 908B. The rear end of the forward shaft portion 908A is provided with a threaded end receiving a nut member 998 for securing together the front and rear shaft portions 908A, 908B of the secondary drive shaft assembly 908.

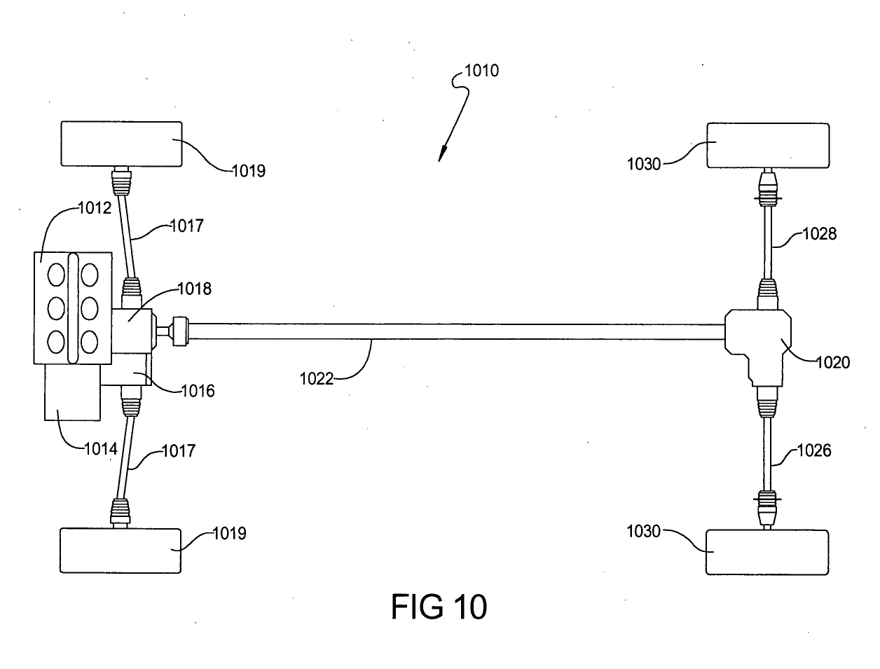

With reference to FIG. 10, an all-wheel drive or four-wheel drive motor vehicle powertrain 1010 is schematically shown. The powertrain is primarily for a front-wheel driven vehicle. The motor vehicle powertrain 1010 is an all-wheel drive or four-wheel drive vehicle and is driven by power transferred from the engine 1012 to a multi-speed transaxle transmission 1014 which may be an automatic or manual gearbox. Power is transferred from the transaxle transmission 1014 to a front or primary differential 1016 which includes a clutch unit for engaging a power take-off unit of the driveline assembly. The front differential 1016 distributes driving torque to two front axle shafts 1017 for driving the front wheels 1019. Power is delivered to the rear differential 1020 via a power take-off unit 1018 that delivers driving torque to propeller (prop) shaft 1022. A torque distributing unit 1024 is incorporated in the front differential for providing driving torque to the power take off unit 1018 for driving the prop shaft 1022, as will be described in greater detail herein. At the rear differential 1020, power is split to a left hand rear side shaft 1026 and a right hand rear side shaft 1028 for distribution to the rear wheels 1030 of the vehicle. The on-demand all-wheel drive vehicle distributes power directly to the front differential 1016 and to the rear differential 1020 via the torque distributing device 1024.

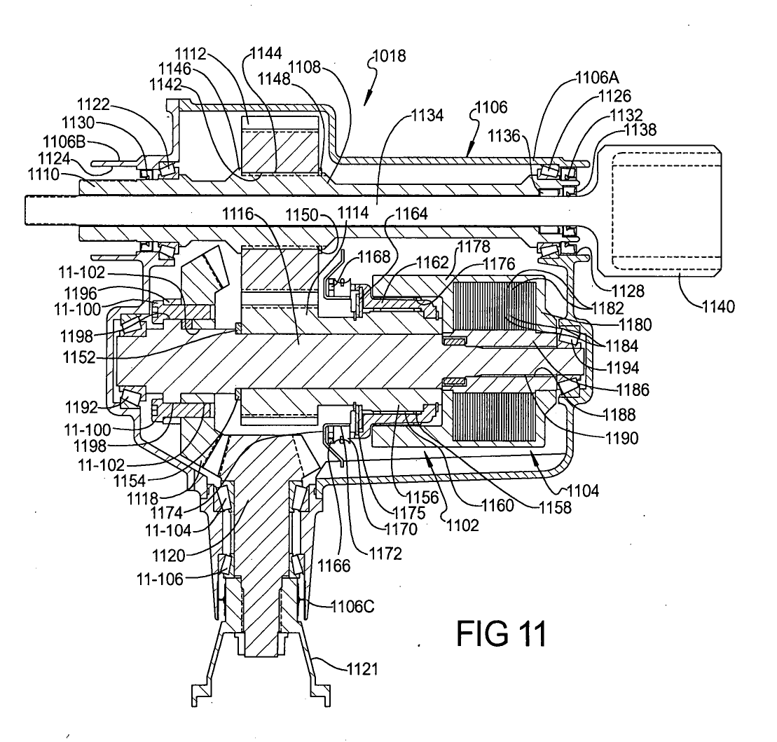

With reference to FIG. 11, a first embodiment of a power take-off unit 1018 is shown having a bi-directional overrunning clutch 1102 and viscous transmission unit 1104 incorporated therein. The power take-off unit 1018 includes a housing 1106 including a main housing portion 1106A, a cover portion 1106B, and an output gear bearing support portion 1116C. The power take-off unit 1118 includes an input shaft 1118 including a splined portion 1110 which is adapted to be engaged with the primary differential 1116 (best shown in FIG. 10). The input shaft 1108 includes a drive gear 1112 fixedly mounted thereto for rotation with the input shaft 1108. The drive gear 1112 is meshingly engaged with a driven gear 1114 which is disposed on an intermediate shaft 1116. The bi-directional overrunning clutch 1102 provides driving torque to the viscous transmission unit 1104 which is connected to the intermediate shaft 1116. A rear output bevel gear 1118 is drivingly connected to the intermediate shaft 1116. The rear output bevel gear 1118 provides driving torque to an output gear 1120 which is drivingly connected to a rear prop shaft 1022, as best shown in FIG. 10 via yoke 1121. The input shaft 1108 is supported within the housing 1106 by a first bearing 1122 provided in an opening 1124 in the cover portion 1106B of the housing 1106 and by a second bearing assembly 1126 provided in an opening 1128 in the main housing portion 1106A.

A first seal 1130 is disposed in the opening 1124 for providing a sealed relationship between the input shaft 1108 and the opening 1124. A second seal 1132 is provided in the opening 1128 between the opening 1128 and the input shaft 118 for providing a sealed relationship therebetween. A front drive axle shaft 1134 which is driven by the primary differential 1016 (best shown in FIG. 10) is co-axially arranged within the hollow input shaft 1108. A needle bearing assembly 1136 is provided between the input shaft 1108 and front drive axle shaft 1134 for rotatably supporting the front drive axle shaft 1134 therein. A seal 1138 is disposed between the input shaft 1108 and the front drive axle shaft 1134 in order to provide a sealed relationship therebetween. The front drive axle shaft 1134 includes a yoke portion 1140 of a universal joint for providing driving torque to one of the front axle shafts 1017. The drive gear 1112 is provided with internal splines 1142 which engage external splines 1144 of the input shaft 1108. The drive gear 1112 is axially secured in place by a shoulder portion 1146 formed on the input shaft 1108 and by a C-clip 1148 received in a groove 1150 formed in the input shaft 1108.

The driven gear 1114 is rotatably supported on the intermediate shaft 1116. A trust bearing 1152 is disposed against the driven gear 1114 and a shoulder 1154 of the intermediate shaft 1116. The driven gear 1114 includes a hub portion 1156 which serves as an inner race for the bi-directional overrunning clutch 1102. As the driving member of the roller clutch 1102, the inner race 1156 has a plurality of cam surfaces 1158 for engaging a respective number of rollers 1160. Preferably, the cam surfaces 1158 are flat, but other configurations may also be suitable.

The rollers 1160 are maintained in position by a roller cage 162 that extend circumferentially around the inner race 156 and extends axially outward forming a skirt 1164 having an end ring 1166. As is known in the art, the roller cage 1162 includes roller openings separated by tangs. At one end of the openings is an index ring that comprises beveled keyways having semi-circular keys terminated by beveled ends and stop ends. The roller cage 1162 also includes shoe retention legs 1168 and shoe separators for retaining and positioning drag shoes 1170 which are disposed adjacent to friction surface 1172. Friction surface 1172 is disposed on a friction plate 1174 which is secured to the housing 1106.

A latch assembly 1175 is provided between the inner race 1156 and skirt 1164 of the bi-directional overrunning clutch 1102. Latch assemblies of this type are generally known in the art as is disclosed in U.S. Pat. No. 5,782,328 which is herein incorporated by reference. The purpose of the latch 1175 is to provide a latch between the inner race 1156 and the roller cage 1162 when the vehicle is driving at high speeds so that when the latch assembly 1175 is engaged, the cage 1162 is coupled to the inner racer 1156. At lower velocities, the latch arms are retracted by springs, as disclosed in U.S. Pat. No. 5,782,328, into non-engaged configuration. As the velocity of the inner race 1156 increases, the arms are urged outward due to centrifugal forces created by the rotation of the shaft. With sufficient centrifugal force exerted, the arms move far enough that they engage the cage 1162 at keyways thus coupling the roller cage 1162 to the inner race 1156. When the roller cage 1162 and inner race 1156 are engaged, no lock-up of the bi-directional overrunning clutch 1102 can occur. An outer race 1176 of the bi-directional overrunning clutch 1102 is formed along an extension arm 1178 of the viscous transmission unit 1104. The viscous transmission unit 1104 provides torque metering to the rear wheels 1030 when the bi-directional overrunning clutch 1102 engages in response to a wheel slip.

The viscous transmission unit 1104 receives input torque from the outer race 1176 of the bi-directional overrunning clutch 1102. The outer race 1176 is fixedly attached to the housing 1180 of the viscous transmission unit 1104. The viscous transmission unit 1104 includes a plurality of externally splined disks 1182 which are in splined connection to the housing 1180, as well as a plurality of interleaved interior splined plates 1184 which are in splined connection to an interior housing portion 1186 which is rotatable relative to housing 1180. The interior housing portion 1186 has internal splines 1188 which are in engagement with external splines 1190 provided on the intermediate shaft 1116. The intermediate shaft 1116 is supported at opposite ends by a first bearing assembly 1192 and a second bearing assembly 1194, each supported within the housing 1106. The intermediate shaft 1116 includes a radially extending flange portion 1196 including a plurality of through holes 1198 through which bolts 11-100 are inserted and threaded into corresponding threaded bolt holes 11-102 of the output bevel gears 1118. The pinion gear 1120 is supported within the output gear bearing support portion 1106C of the housing 1106 by bearing assemblies 11-104 and 11-106.

In operation, the rear differential is designed to have a smaller gear ratio than a front differential so that during normal operation (without wheel slip), the intermediate shaft 1116 rotates faster than the driven gear 1114 so that the outer race 1176 is able to override without causing any lockup of the bi-directional overrunning clutch 1102. However, during an instance of wheel slip, such as the front wheels slipping due to an icy road surface, the faster relative rotation of the driven gear 1114 causes lockup of the bi-directional overrunning clutch 1102 which will then distribute torque to the viscous transmission unit 1104 which will meter distribution of the torque to the rear wheels through the rear output bevel gear 1118 and prop shaft 1022.

The description of the invention is merely exemplary in nature and, thus, variations that do not depart from the gist of the invention are intended to be within the scope of the invention. Such variations are not to be regarded as a departure from the spirit and scope of the invention.

1. A clutch device, comprising:
a housing;
an input shaft extending into said housing and including an integrally formed flange portion disposed outside of said housing;
an inner race member connected to said input shaft;
a plurality of rollers disposed in contact with said inner race member; and
a roller cage surrounding said inner race member and supporting said plurality of rollers in contact with said inner race member.

2. The clutch device according to claim 1, further comprising a viscous transmission unit defining an outer race engaging said plurality of rollers.

3. The clutch device according to claim 2, wherein said viscous transmission unit includes a plurality of interleaved plates disposed radially outward of said plurality of rollers.

4. The clutch device according to claim 2, wherein said viscous transmission unit includes a plurality of interleaved plates spaced axially from said plurality of rollers.

5. The clutch device according to claim 2, further comprising an output shaft drivingly connected to said viscous transmission unit.

6. The clutch device according to claim 5, wherein said viscous transmission unit includes a hub portion attached to said output shaft.

7. The clutch device according to claim 6, further comprising a bearing assembly disposed between said hub portion and said input shaft.

8. The clutch device according to claim 1, wherein said inner race includes a plurality of internal splines connected to external splines on said input shaft.

9. The clutch device according to claim 8, further comprising a retaining member engaging an end portion of said input shaft for securing said inner race member on said input shaft.

10. The clutch device according to claim 1, further comprising a drag shoe mechanism connected to said roller cage and engaging a friction surface disposed directly on said housing.

11. The clutch device according to claim 2, further comprising a bearing assembly disposed between said viscous transmission unit and said input shaft.

12. The clutch device according to claim 1, further comprising a high speed latch assembly connected to said input shaft and engageable with said roller cage.

13. A clutch device, comprising:
a housing;
an input shaft extending into said housing;
an inner race member driven by said input shaft;
a plurality of rollers disposed in contact with said inner race member; and
a roller cage surrounding said inner race member and supporting said plurality of rollers in contact with said inner race member;
an outer race member surrounding said inner race member and engaged with said plurality of rollers; and
a drag shoe mechanism connected to said roller cage and engaging a friction surface disposed directly on said housing.

14. The clutch device according to claim 13, further comprising a viscous transmission unit defining said outer race.

15. The clutch device according to claim 14, wherein said viscous transmission unit includes a plurality of interleaved plates disposed radially outward of said plurality of rollers.

16. The clutch device according to claim 14, further comprising an output shaft drivingly connected to said viscous transmission unit.

17. The clutch device according to claim 13, further comprising a high speed latch assembly connected to said input shaft and engageable with said roller cage.

18. A clutch device, comprising:
an input shaft;
an inner race member driven by said input shaft;
a plurality of rollers disposed in contact with said inner race member; and
a roller cage surrounding said inner race member and supporting said plurality of rollers in contact with said inner race member;
an outer race member surrounding said inner race member and engaged with said plurality of rollers; and
a viscous transmission unit defining said outer race, wherein said viscous transmission unit includes a plurality of interleaved plates disposed radially outward of said plurality of rollers.

19. The clutch device according to claim 18, wherein said inner race member includes a splined connection to said input shaft.

20. The clutch device according to claim 19, further comprising a retaining member engaging an end portion of said input shaft for securing said inner race member on said input shaft.

21. The clutch device according to claim 18, further comprising a housing including a friction surface disposed directly thereon and a drag shoe mechanism connected to said roller cage and engaging said friction surface.

22. The clutch device according to claim 18, further comprising a bearing assembly disposed between said viscous transmission unit and said input shaft.

23. The clutch device according to claim 18, further comprising a high speed latch assembly connected to said input shaft and engageable with said roller cage.

24. A clutch device, comprising:
a housing;
an input shaft extending into said housing;
an inner race member having an interior spline connected to an exterior spline of said input shaft;
a plurality of rollers disposed in contact with said inner race member; and
a roller cage surrounding said inner race member and supporting said plurality of rollers in contact with said inner race member.

25. The clutch device according to claim 24, further comprising a viscous transmission unit defining an outer race engaging said plurality of rollers.

26. The clutch device according to claim 25, further comprising an output shaft drivingly connected to said viscous transmission unit.

27. The clutch device according to claim 26, further comprising a bearing assembly disposed between said viscous transmission unit and said input shaft.

28. The clutch device according to claim 24, further comprising retainer means engaging said input shaft for securing said inner race member on said input shaft.

29. The clutch device according to claim 24, further comprising a drag shoe mechanism connected to said roller cage and engaging a friction surface disposed directly on said housing.

30. The clutch device according to claim 24, further comprising a high speed latch assembly connected to said input shaft and engageable with said roller cage.

31. A vehicle powertrain, comprising:
a multi-speed transaxle transmission;
a primary differential driven by said multi-speed transaxle transmission;
a power take-off unit associated with said primary differential; and
a rear prop shaft drivingly connected to a secondary differential, wherein said power take-off unit includes an overrunning clutch for delivering drive torque to said prop shaft.

32. The vehicle powertrain according to claim 31, further comprising a viscous transmission unit, wherein said power take-off unit includes a driven gear supported by an intermediate shaft, wherein a first race member of said overrunning clutch is connected to said driven gear and an output member of said viscous transmission unit is connected to said intermediate shaft.

33. The vehicle powertrain according to claim 32, wherein said overrunning clutch includes a second race member that provides an input to said viscous transmission unit.

34. The vehicle powertrain according to claim 31, wherein said overrunning clutch is supported on an intermediate shaft which is generally perpendicular to an axis of rotation of said rear prop shaft.

35. The vehicle powertrain according to claim 34, further comprising a high speed latch assembly connected to said intermediate shaft and engageable with a roller cage of said overrunning clutch.

36. A vehicle powertrain, comprising:
a multi-speed transaxle transmission;
a primary differential driven by said multi-speed transaxle transmission;
a power take-off unit associated with said primary differential; and
a first rear prop shaft segment drivingly connected to said power take off unit;
a mid mounted torque distribution unit drivingly connected to said first rear prop shaft segment, said mid mounted torque distribution unit including an overrunning clutch and a viscous transmission unit; and
a second rear prop shaft segment drivingly connected at a first end to said viscous transmission unit and having a second end drivingly connected to a secondary differential, wherein said mid mounted torque distribution unit includes a first housing that is spaced from a second housing of said primary differential and a third housing of said secondary differential.

37. The vehicle powertrain according to claim 36, wherein said first housing includes mounting features adapted for mounting the first housing to an underside of a vehicle.

38. The vehicle powertrain according to claim 36, further comprising a high speed latch assembly drivingly connected to said first rear prop shaft segment and engageable with a roller cage of said overrunning clutch.
